(19) United States
(12) Patent Application Publication
(10) Pub. No.: US 2018/0047046 A1
(43) Pub. Date: Feb. 15, 2018

(54) METHODS AND SYSTEMS FOR OBTAINING A REWARD FROM A LOYALTY PROGRAM

(71) Applicant: MASTERCARD INTERNATIONAL INCORPORATED, Purchase, NY (US)

(72) Inventors: Geetika Sharma, New Delhi (IN); Charu Jain, Singapore (SG); Ankit Shreemal, Gurgaon (IN)

(21) Appl. No.: 15/677,570

(22) Filed: Aug. 15, 2017

(30) Foreign Application Priority Data
Aug. 15, 2016 (SG) 10201606772Q

(51) Int. Cl. G06Q 30/02; G06Q 40/02

(52) U.S. Cl. CPC G06Q 30/0233; G06Q 40/02; G06Q 30/0215

(57) ABSTRACT

A computer-implemented method and computer system are proposed for assisting a consumer associated with a plurality of loyalty programs, and who wishes to obtain a reward using loyalty points. The consumer interacts with a computer system with access to a database containing information about the loyalty programs with which the consumer is associated and the number of points the consumer has accumulated in each program, and at least one reward database storing information relating to rewards on offer using the loyalty programs. The consumer specifies one or more parameters of the desired reward, and the computer system uses the databases to make at least one recommendation of which of the loyalty programs to use to obtain a reward with the specified parameters.

### FIELD OF THE INVENTION

The present invention relates to computer systems and computer-implemented methods for assisting a consumer to obtaining rewards using a loyalty program.

### BACKGROUND OF THE INVENTION

It is common for a merchant to organise a loyalty program for its customers. Typically, a customer is provided with a physical loyalty card, which is typically a piece of paper or plastic carrying a membership number. The membership number is the number of a loyalty account for storing loyalty points earned by the customer. Whenever the customer makes a purchase at a point-of-sale (POS) of the merchant they present the loyalty card. Depending on the value of the purchase, the merchant determines a corresponding number of loyalty points, and credits that number of loyalty points to the account associated with the corresponding card. The accumulated loyalty points can be used to obtain rewards, such as goods and/or services (collectively referred to here as “products”) or a discount on a future purchase from the merchant. The advantage of the rewards system for the merchant is that once the customer has accumulated some loyalty points, he or she is more likely to make future purchases from the same merchant in the hope of eventually earning a reward.

Other loyalty programs are operated by companies other than merchants. For example, sometimes a payment card issuer operates a loyalty program in which consumers are rewarded with loyalty points for making purchases using a payment card. The payment card issuer may offer a range of products which may be obtained using the loyalty points, and/or may permit the payment card holder to convert the loyalty points into loyalty points of a different loyalty program.

A disadvantage of known loyalty card systems is their lack of transparency to the customer. Sometimes a customer who has in fact already accumulated significant loyalty points, does not know this, or does not know what rewards could be obtained using the accumulated loyalty points, and is not incentivised to use the corresponding merchant again in order to continue to accumulate them. Such a customer may become a member of another loyalty program organised by the merchant's competitor. In other words, the value of the loyalty program is lost both to the merchant and the customer. The consumer may end up spending money on a product which in fact the consumer could have obtained using loyalty points instead of money.

Furthermore, typically a customer signs up with a plurality of loyalty programs, each of which offers different rewards, at different times, in exchange for different numbers of loyalty points. There is no standardization between these programs, so the “burn rate” (that is, the number of loyalty points which the customer uses (“burns”) to obtain a reward of a given financial value) varies widely from one loyalty program to another. Indeed, even for a given loyalty program, the burn rate may vary widely from one product to another. For example, on a given loyalty program it may happen that a product costing $351 can only be redeemed for twice as many loyalty points as a product costing $350, i.e. the product costing $351 has a burn rate almost twice as high as the product costing $350.

Furthermore, in many loyalty programs the loyalty points have a finite lifetime, and a customer may not be aware that loyalty points are about to expire. If the customer realizes this too late, when the points have already expired, then the customer has lost his chance to obtain a reward. This may cause him or her such annoyance that he or she stops using the company which offers the loyalty program.

### SUMMARY OF THE INVENTION

The present invention aims to provide new and useful computer systems and computer-implemented methods for assisting customers to obtain rewards using loyalty points of a loyalty program.

In general terms, the invention proposes that, when a consumer associated with a plurality of loyalty programs wishes to obtain a reward, the consumer interacts with a computer system with access to one or more reward databases storing information relating to rewards on offer using the loyalty programs. The consumer specifies one or more parameters of the desired reward, and the computer system uses the databases to identify a reward matching the specified parameters.

In this way, the consumer is given greater information about the options to obtain rewards. This makes the consumer more likely to take up one of the reward offers, and thus in turn makes the loyalty programs themselves more attractive to consumers.

Typically, the computer system includes a communication device associated with (e.g. owned by, carried by or at premises of) the consumer. For example, the communication device may a mobile communication device such as a smartphone or tablet computer. A software application may be installed on the communication device, and the communication device may also store one or more databases.

Furthermore, the computer system preferably includes at least one loyalty program management server remote from the communication device, and the communication device is in communication with the loyalty program management server over a communication network. One or more of the reward databases may be remote from the communication device and controlled by the server. The loyalty program management server may be in communication with program servers associated with the operators of the loyalty programs, for providing information to populate the reward databases.

Optionally, the communication device may be operative (e.g. under control of the software application) to populate a reward database, such as one stored on the communication device. Thus, if the communication device receives a message, such as an electronic direct marketing (eDM) message, specifying an available reward, the communication device may use it to populate the reward database.

The consumer may specify the one or more parameters of the desired reward in various ways. A first way would be for software application on the communication device to present to the consumer a graphical user interface (GUI) which allows the consumer to specify a reward, such as by entering search terms and/or by selecting from pre-defined options presented by the GUI. Optionally, the software application may obtain information about which pre-defined options to offer from a remote source, such as a reward database of the loyalty program management server.

In an alternative, the consumer may specify the one or more parameters of the desired reward by scanning information into the communication device. For example, if the consumer is in a retail location, and sees a product which he or she would like as a reward, the consumer may scan into the communication device a graphical symbol such as a barcode or QR (quick response) code displayed with the product. The graphical symbol encodes parameters of the product, such as a stock keeping unit (SKU) code which uniquely identifies the product within a predefined inventory management system.

Thus, the parameters specified by the consumer may be precise enough to uniquely specify the reward. Alternatively, the computer system may perform a search for one or more rewards meeting the specified parameters. Optionally, the consumer may be invited to confirm whether one of more of the results of the search are the desired reward. In this way, the consumer provides additional parameters describing the reward.

The computer system then identifies the loyalty programs which offer rewards meeting the criteria. These loyalty programs are termed “matching loyalty programs”, and for each of these there may be one of more rewards which are available meeting the specified parameters (the “matching rewards”). Each of the matching rewards is offered by the corresponding matching loyalty program in the form of a “matching reward offer”.

If there are multiple matching rewards, the computer system may present information about one or more of the matching rewards in such a way as to make a recommendation as between the matching reward offers. The may be done for example by calculating a respective score for each of the matching reward offers, and presenting the information about the matching rewards according to the score (e.g. in an order determined by the score, or with the information about the matching reward corresponding to the highest score highlighted).

The computer system may use one or more score criteria to calculate the respective score of each matching reward offer.

A first of the score criteria may be based on the number of loyalty points which is required to obtain the reward using each respective loyalty program. Conventionally, the “earn rate” of a loyalty program refers to the number of loyalty points which a consumer earns per unit of currency (e.g. per dollar) of spending to earn the loyalty points. The “burn rate” of a certain reward in a certain loyalty program conventionally refers to the financial value of the reward divided by the number of loyalty points of the program required to obtain the reward. The product of the “earn rate” and the “burn rate” is a value indicative of the financial value of the reward per unit of currency of spending to earn loyalty points in the loyalty program. Thus, the computer system may employ as a score criterion how low this value is for each matching reward. If the earn rate for the loyalty programs is assumed to be standardized, then this would amount to selecting the loyalty program for which the “burn rate” for the matching reward is lowest.

A second of the score criteria may be that the consumer has already earned enough loyalty points in the corresponding matching loyalty program to pay for the reward.

Sometimes multiple loyalty programs co-operate, such that points in one loyalty program are convertible into points in another loyalty program, or such that points from multiple corresponding loyalty programs may be used in combination to earn a reward. Thus, optionally, the second score criteria may take these possibilities into account when determining whether the consumer has enough points to buy the rewards. Thus, a matching loyalty program may still be selected if a reward available through the program could be obtained by using the accumulated loyalty points for that program in combination with loyalty points from another of the loyalty programs.

Alternatively or additionally, the second score criterion may take into account the fact the consumer may earn sufficient loyalty points in the future to buy the reward. In other words, the score criterion may determine a shortfall in the number of accumulated loyalty points, and still select the matching loyalty program if the shortfall meets a shortfall criterion (e.g. is below a predetermined value).

The shortfall criterion may be calculated using data characterizing the consumer's payment history, since the payment habits would be indicative of the consumer's ability to earn the required loyalty points in the future.

For example, the computer system may use the data characterizing the consumer's payment history to develop a model of the consumer's behaviour, which permits the computer system to make a probabilistic prediction about the consumer's future payments, and thus the ability of the consumer to accumulate the required loyalty points, e.g. by a specific date which may be specified by the consumer and/or be a parameter of a reward offer made by a loyalty program (e.g. the latest date on which a consumer may be able to obtain the reward using loyalty points). In other words, the computer system may suggest a loyalty program to use based on spending the consumer may make during a time period extending into the future, e.g. during a certain number of weeks, months or even years in the future, based on a probabilistic prediction of the consumer's behaviour during that future time period.

The communication device (typically under control of the software application) may be operative to notify the consumer when the points required to earn the reward have been accumulated. In a variation of this, this communication device may be operative to generate message(s) at intervals during the time period to indicate progress in accumulating the required loyalty points.

A further score criterion the computer system might use is based on properties of the consumer, such as a geographical location associated with the consumer (e.g. the consumer's residence address). The computer system may in this case select reward offers at least partly based on the proximity to the geographical location of an outlet where the consumer is able to obtain the reward using the loyalty points.

If the consumer accepts a reward offer recommended by the computer system by inputting a corresponding command into the communication device, the communication device may be operative to notify the consumer of one or more redemption locations where the matching reward can be obtained using the loyalty points of the corresponding loyalty program. These may be location(s) which are selected as the closest such locations to the geographical location associated with the consumer. The consumer may be notified of the redemption locations using data displayed on the GUI. The communication device may obtain this data from the loyalty program management server, optionally under control of the software application.

The communication device, typically under control of the software application, may have one or more further functionalities.

Firstly, it may be operative to alert the consumer when a new reward is added to the offers of a loyalty program and which matches a search the consumer had previously made.

Secondly, the communication device may be operative to notify the consumer when the consumer has accumulated enough loyalty points to earn a reward in which the consumer previously indicated an interest.

Thirdly, the communication device may, e.g. in response to a command from the consumer, provide the consumer with information about the points accumulated in each of the loyalty programs, such as information about any points which will expire within a predetermined period in the future. More generally, it may give the consumer historical information about the consumer's interaction with the loyalty program, such as a transactions summary indicating when the consumer earned loyalty points and/or a redeemed summary indicating the rewards the consumer has previously earned.

Furthermore, the communication device might be used as an alternative to a conventional loyalty card. For example, when a consumer wants to make a purchase to earn points in a certain loyalty program, the consumer may cause the communication device to transmit a message to a point-of-sale (POS) terminal. The message would encode the consumer's membership number in the loyalty program, and thus would make it unnecessary to present a conventional paper or plastic loyalty card. For example, the communication device might generate the message by using a screen of the communication device to present a graphical symbol (e.g. a barcode or a QR code) which an image capture system of the POS terminal can use to recognise that the consumer is a member of the loyalty program and capture the membership number. Alternatively, the communication device might transmit the message to the POS terminal by wireless electromagnetic data communication. The communication may be according to any conventional protocol, such as a near-field communication (NFC).

The invention may be expressed as a computer implemented method, or as a computer system arranged to perform the method, such as one including a processor and a data storage device storing program instructions operative, when performed by the processor, to cause the processor to perform the steps of the method. Optionally, the loyalty program management system may be a computer system which is further arranged to operate as a payment network server for a payment card network server. This would give the loyalty program management system further opportunities to gather the historic data characterizing past spending by the consumer.

As used in this document, the term “loyalty program” refers to a commercial agreement made between a provider of the loyalty program and a consumer, such that the consumer becomes a member of the program (“registers with the program”) upon making the agreement. The provider of the loyalty program establishes a personal account for the consumer with the loyalty program. The account is for storing loyalty points, which are not monetary currency (e.g. legal tender). When a registered consumer makes purchases of a type specified in the commercial agreement, a number of loyalty points dependent upon the value of the purchase according to a formula specified in the commercial agreement, are credited to the account. The loyalty program makes “reward offers” which permit registered consumers to obtain rewards (products) in exchange for a certain number of the accumulated loyalty points.

As used in this document, the term “payment card” refers to any cashless payment device associated with a payment account, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, transponder devices, NFC(near field communication)-enabled devices, and/or computers. Furthermore, the “payment card” may exist only as a data structure (i.e. without physical existence), which is registered with a digital wallet or cloud wallet.

### BRIEF DESCRIPTION OF THE DRAWINGS

An embodiment of the invention will now be described for the sake of example only with reference to the following figures, in which:

FIG. 1 shows schematically a computerized network including a computer system which is an embodiment of the present invention.

FIG. 2 shows schematically the structure of a software application used in the computer system of FIG. 1.

FIG. 3 is a flow diagram of steps performed by the computer system of FIG. 1 during a consumer registration procedure.

FIG. 4 is a flow diagram of steps performed by the computer system of FIG. 2 in a method which is an embodiment of the invention.

FIG. 5 shows the structure of a server system which may be used in the computerized network of FIG. 1.

FIG. 6 shows the structure of a portable communications device which may be used in the computerized network of FIG. 1.

### DETAILED DESCRIPTION OF THE EMBODIMENTS

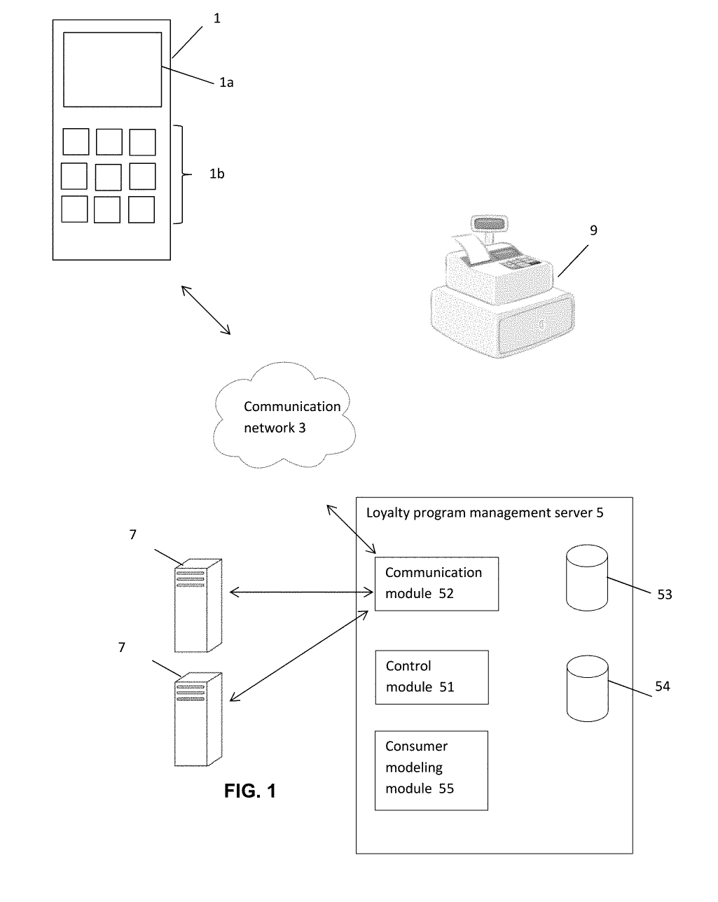

Referring firstly to FIG. 1, a computerized network is shown including a communication device 1 associated with an individual (here a “consumer”). The communication device 1 is an embodiment of the invention, and interacts with a loyalty program management server 5 to perform a method which is an embodiment of the invention. Although the method is explained below with reference only to a single consumer, in a typical embodiment the consumer is one of a large number of consumers (e.g. at least 100) who use respective communication devices to interact with the loyalty program management server 5.

Each of the consumers is registered with a respective plurality of loyalty programs, the loyalty programs for each consumer being a respective subset of a predetermined set of loyalty programs, which are here called the “supported loyalty programs”.

The communication device 1 may be a mobile device, such as a smartphone or tablet computer. The communication device 1 includes a screen 1a and one of more data input devices 1b. The communication device 1 is operative to communicate with a communication network 3 such as the internet.

The loyalty program management server 5 includes a control unit 51 with processing capacity, and a communication module 52 which provides a communication interface between the loyalty program management server 5 and the communication network 3, so that the communication device 1 and loyalty program management server 5 can interact via the communication network 3.

The loyalty program management server 5 includes a consumer database 53 for storing respective records relating to the multiple consumers. The record for each consumer indicates the loyalty programs with which the consumer is registered, and information about the consumer's membership of each of those loyalty programs, such as the number of points the consumer has accumulated in the program.

The loyalty program management server further includes a reward database 54 which, for each of the supported loyalty programs, shows one or more rewards which may be obtained by using corresponding numbers of loyalty points of a corresponding loyalty program. In other words, the reward database 54 stores reward offers to supply respective rewards to consumers in exchange for respective specified numbers of loyalty points in a respective loyalty program. For each reward offer, the reward database 54 may include condition data specifying any conditions associated with the reward offer (for example, that the reward has to be redeemed by a specific date). Furthermore, the rewards database 54 may store association data characterizing any associations which may exist between loyalty programs, such as arrangements that points from one loyalty program may be converted into points of another loyalty program, or such that loyalty points from multiple loyalty programs may be combined to obtain a reward offered by one of those programs.

The loyalty program management server 5 is able to populate the rewards database 54 by communicating, using the communication module 52 with respective servers 7 operated by the organizers of the supported loyalty programs (for simplicity only two such servers 7 are shown, but there may be a different number of such servers).

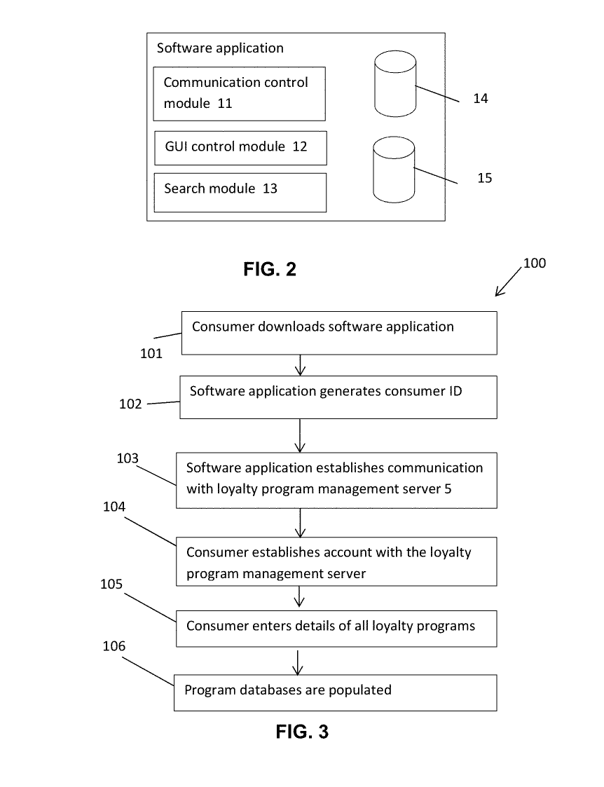

Installed in the communication device 1 is a software application, which the consumer may have downloaded from the loyalty program management server 5, or from elsewhere. The structure of the software application is shown schematically in FIG. 2. It includes a communication control module 11 for controlling communication with the loyalty program management server 5 via the communication network 3. It further includes a GUI control module 12 for presenting a GUI to the consumer using the screen la of the communication device 1. It further includes a search module 13, explained below. It further includes a personal database 14 for storing information relating to the consumer, including the loyalty programs the consumer is registered with. Optionally, it further includes a personal rewards database 15 for storing information about reward offers which have been made to the consumer.

Referring to FIG. 3, a method 100 is shown by which the consumer initiates the software application. In step 101, the consumer downloads the software application to the communication device 1 and opens it. At this point, the consumer may be prompted to enter into the software application one or more geographical locations associated with the consumer (e.g. the consumer's residential work address and/or work address). The software application may store the information in the personal database 14.

In step 102, the software application generates a unique consumer ID number. This may be done for example based on properties of the communication device 1, e.g. by using a manufacturer's identity number of the device as the seed of a random number generator algorithm.

In step 103, the software application uses the communication module 11 to establish contact with the loyalty program management server 5 via the communication network 3. All future communication between the software application and the loyalty program management server 5 is managed by the communication module 11 of the communication device 1, and the communication module 52 of the loyalty program management server 5.

In step 104, the software application (possibly following a command by the consumer entered into the communication device 1) sends a message to the loyalty program management server 5 containing the customer ID number. The message instructs the loyalty program management server 5 to open an account for the consumer, referenced by the unique consumer ID number. The loyalty program management server 5 generates a new record for the consumer in the consumer database 53. All future communications from the software application to the loyalty program management server 5 (and optionally in the other direction) include the customer ID number so that the loyalty program management server 5 is able to correctly associate them with the consumer's record in the personal database 14.

Note that in a variation of the embodiment, step 102 may be omitted, and the consumer ID could instead be generated in step 103 by the loyalty program management server 5 (or taken from the top of list of unused, pre-generated consumer IDs).

In step 105 the consumer enters into the communication device 1 details of a plurality loyalty programs with which the consumer is registered, and the consumer's respective membership numbers in each of those programs. The software application stores this data in the personal database 14, and transmits it to the loyalty program management server 5 which stores it in the corresponding record in the database 53. The loyalty programs specified in step 105 must be a subset of a pre-defined set of loyalty programs supported by the loyalty program management server 5.

In step 106, the loyalty program management server 5 communicates with the corresponding one(s) of the servers 7 to obtain information about the consumer's membership in each of the programs specified in step 105. This information comprises, for example, the number of points the consumer has accumulated in the loyalty programs for which he or she is registered. The data may further include a list of transactions the consumer has made redeeming loyalty points, e.g. including details of which rewards were obtained by redeeming loyalty points and/or where the rewards were obtained (e.g. which shop, mall and/or retail location). This data is included in the consumer's record in the consumer database 53. The loyalty program management server 5 may transmit the data also to the software application, which stores it in the personal database 14.

It will be understood that in possible variants of the invention, either of the personal database 14 or the consumer database 53 may be omitted, such that the computerized network relies upon the other of those databases 14, 53. However, providing at least partly mirrored databases in the software application and the loyalty program management server 5 minimizes the amount of data which is transferred within the system, and also means that the software application has some functionality when, for some reason, communication via the communication network 3 is temporarily unavailable.

Henceforth, using the software application, the consumer is able to use the software application to obtain details about the loyalty programs the consumer is registered with. This data may be obtained from the personal database 14 or from the consumer database 53.

Optionally, the software application contains a database 15 which mirrors part of the database 54. It may for example contain details of the reward offers available for the loyalty programs for which the consumer is registered. The database 15 would mean that the software application would have some functionality even when the communication device is unable to communicate with the loyalty program management server 5. The database 15 may be updated from the database 54 at intervals.

Optionally, the loyalty program management server 5 may include a consumer modeling module 55 which forms a model of the consumer based on the data in the corresponding record in the consumer database 53. For example, the model may include an estimate of how many loyalty points the consumer will accumulate in each of the loyalty programs in a corresponding future period. In a more sophisticated variant, the model may include how much a certain product type (e.g. petroleum) the consumer will buy in a certain future period, and thus how many loyalty points the consumer could accumulate in the future period if the consumer switched his or her spending on the product type to a merchant associated with a certain one of the supported loyalty programs.

Once the model is generated, it may optionally be transmitted to the software application, and stored in the database 14. Note that the consumer modeling module may optionally be provided within the software application rather than in the loyalty program management server 5.

Optionally, either the software application or the loyalty program management server 5 is operative to monitor whether accumulated loyalty points are about to expire, and in this case to generate a message to the consumer using the communication device 1.

Suppose that the consumer wishes to make a purchase at a point-of-sale (POS) terminal 9 located at a retail location, and the consumer wishes to make a purchase to accumulate loyalty points in one of the loyalty programs with which he is registered. The software application uses data in the personal database 14 to generate and transmit to the POS terminal 9 a message encoding the consumer's membership number in that loyalty program. For example, the software application may display on the screen la a graphical symbol (such as a barcode or a QR symbol) which can be recognized by an optical scanner of the POS terminal 9, to give the consumer's membership number in the loyalty program. In this way, the communication device 1 functions as an alternative to a conventional physical (paper or plastic) loyalty card. In an alternative, the communication device 1 may establish wireless communication with the POS terminal 9 (e.g. by a NFC-protocol message) to transmit to the POS terminal 9 a wireless message containing the consumer's membership number in the loyalty program.

In a further alternative, if the consumer wishes to use the communication device 1 to make a purchase from an online merchant to which the communication device 1 is connected via the communication network 3, the software application may transmit details of a relevant one of the loyalty programs with which the consumer is registered to the online merchant over the communication network 3.

In either case, upon the purchase being completed, the consumer's account at the specified loyalty program is credited with the loyalty points earned. This information is generally recorded with a corresponding one of the servers 7, which in turn transmits the information to the loyalty program management server 5, so that the consumer's record in the database 53 can be updated. Furthermore, the consumer modelling module 55 may update the model of the consumer in the databases 14 and 53.

If the consumer joins a new loyalty program, then the consumer is able to use the data input devices 1b of the communication device 1 to control the software application and to enter details of the new loyalty program, such as the consumer's membership number in the new loyalty program. The software application may accordingly update the databases 14, 15 and 53.

Alternatively, if the consumer joins a new loyalty program when the consumer is at a retail location, the software application may be able to capture all the required information from the POS terminal 9. For example, this may be by the communication device 1 receiving a wireless message from the POS terminal 9 encoding a new membership number, or by a camera of the communication device 1 capturing an image of a graphical display generated by the POS terminal 9 and encoding the new membership number.

Occasionally, the consumer may receive an electronic Direct Marketing (eDM) message (for example by email). Sometimes an eDM notifies a consumer that bonus points have been credited to one of the loyalty programs the consumer is registered with. The bonus points may only be available provided that the user makes a certain additional purchase. Alternatively or additionally, the eDM may make an reward offer which is specific to the consumer.

In any case, the communication device 1 may be operative, under control from the consumer, to forward an eDM message to the software application. If the eDM message contains a reward offer, the software application may store that reward offer in the personal reward database 15. Note that in a variation of the method, the reward database may be omitted and the reward may be stored, for example, in the consumer's record in the database 53.

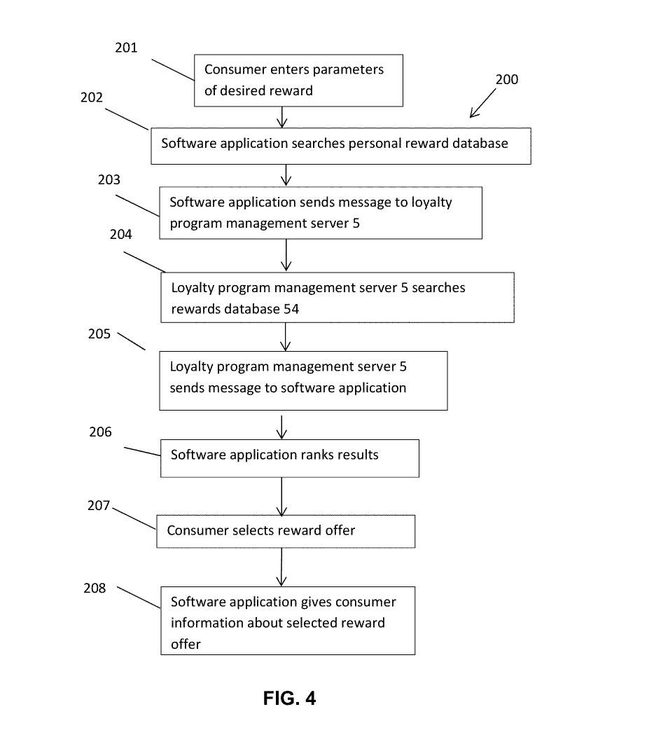

Turning now to FIG. 4, the steps are shown of method 200 which is an embodiment of the invention, and which is performed by the computerized network of FIG. 1.

In step 201, the consumer decides to obtain a reward, and uses the data input devices 1b to enter one or more parameters describing the desired reward into the software application. For example, one parameter may be that the reward is a watch.

The consumer may be able to specify the parameters by selecting from pre-defined options offered to him by the GUI. For this purpose, the software application may store a number of pre-defined options for the parameters (e.g. a list of pre-defined reward categories), and/or be able to obtain these options from the loyalty program management server 5. For example, if the software application stores a number of pre-defined reward categories, one of which is “watches”, and the consumer selects that reward category, the software application may contact the loyalty program management sever 5 to obtain a corresponding set of more specific options (e.g. watches made by specific manufacturers, or watches in particular styles), and present the more specific options to the consumer using the screen la, for the consumer to make a selection.

Alternatively or additionally, the consumer may be able to specify the parameters by entering text, such as the word “watch” into a text-box which is part of the GUI generated by the software application.

In step 202, the search module 13 of the software application searches the personal reward database 15 for offers meeting the specified parameters. Note that in variants of the embodiment in which the reward database 15 is omitted, the search module 13 may be omitted also and so is step 202.

In step 203, the software application transmits a message to the loyalty program management server 5 including the specified parameters. The message instructs the control module 51 of the software application to perform a search in the reward database 54 for reward offers relating to rewards matching the criteria.

In step 204, the control module 51 determines from the consumer database 53 which loyalty programs the consumer is a member of, and searches the rewards database 54 for rewards matching the specified parameters. This search is carried out only in respect of reward offers for the loyalty programs for which the consumer is registered. The result is a list of matching reward offers.

In step 205, the loyalty program management server 5 passes information about the rewards offers for the matching rewards to the software application. The information may include information about locations at which the rewards may be obtained. Note that if the database 15 is included in the software application, then steps 204 and 205 of the method may be omitted.

In step 206, the software application ranks the reward offers for the matching rewards identified in steps 202 and 204. It may do this by calculating a respective score for each matching reward offer, using one or more score criteria. For example, it may generate a score for each reward offer by combining (e.g. adding) respective numbers calculated using each of multiple score criteria, and it may list the reward offers in an order depending upon their respective scores.

For example, one of the score criteria may be whether the consumer has already accumulated the required number of loyalty points in the corresponding loyalty program to purchase the item. In determining this, the software application may take into account points in other loyalty programs which can be used in combination with loyalty points of the program offering the reward. The information about which loyalty programs' points may be combined in this way may have been included the details of the reward offer stored in the reward databases 15 and 54, and included in the message sent by the loyalty program management server 5 in step 205.

A more sophisticated version of this score criterion might also take into account predicted future spending of the consumer, based on the model constructed by the consumer modeling module 55.

A second score criterion might be based on the proximity of any location at which the reward can be obtained to the consumer location specified at step 101.

A third score criterion might be based on the “burn rate” of the matching reward offers. Supposing that all the loyalty programs have equivalent earn rates (or that, if not, the burn rates for each reward offer have been normalized to compensate for the differing earn rates), a given reward offer may be given a higher score if the “burn rate” is less. Thus, if identical rewards are offered by multiple loyalty programs, rewards with a lower burn rate will be higher in the list suggested to the consumer.

In step 207, the consumer makes a selection of one of the listed reward offers, to indicate that the consumer is interested in accepting the reward offer. A list may be stored in the database 14 of reward offers which the consumer has indicated an interest in accepting.

In step 208, the software application accordingly uses the screen 1a to inform the consumer of locations where the reward can be obtained.

If the reward offer selected by the consumer is one for which the consumer has not yet accumulated sufficient loyalty points, the software application may register the selection in the personal database 14, and at intervals send the consumer alerts about the consumer's progress in accumulating loyalty points to reach the required number of loyalty points. For example, the software application may generate an alert when a sufficient number of points to obtain the matching reward has been reached. Before that, it may generate messages at intervals indicating how many loyalty points still need to be earned, so that the consumer is prompted to make additional purchases to earn the loyalty points. The timing and/or content of the messages may depend upon a limit date. The limit date may be one specified by the consumer (i.e. a data by which the consumer wishes to be able to obtain the matching reward), or be a date specified by the reward offer (e.g. an expiry date after which the reward offer is no longer valid).

Optionally, the set of parameter(s) specified during a reward search may be stored, e.g. in the personal database 14 and/or the consumer database 53. If the database 54 is updated to include a new reward offer including a reward matching one of the stored sets of parameter(s), a message may be sent to the consumer.

We now present two examples of the method 200.

In the first example, in step 201 the consumer specifies that he or she wants a reward which is a watch. In steps 202 and 204 reward offers relating to watches are identified. In step 206, the software application listed the identified reward offers, with those having the lowest burn rate highest in the list.

In the second example, in step 201 the consumer specifies that he or she wants a reward which is a holiday to Bali. In steps 202 and 204, reward offers relating to holidays in Bali are identified. The software application determines that the consumer does not have sufficient loyalty points for any of these matching reward offers. However, in step 206 the software application uses the consumer model based on the consumer's spend and redemption past behavior, to identify matching rewards for which the consumer will most easily be able to accumulate the required loyalty points and gives those a higher score, so that they appear at the top of the list presented in the GUI.

Supposing that the consumer selects one of the reward offers presented by the GUI, the software application records this fact, and notes any expiry date of the selected reward offer. The software application generates messages to the consumer at intervals informing the consumer of progress towards accumulating the required number of points and/or the approach of the expiry date. If the communication device 1 subsequently receives an eDM which advertised a purchase which the consumer can make thereby earning loyalty points, the software application may prompt the consumer to make the purchase using a loyalty program which will earn the consumer loyalty points of the kind required by the selected reward offer. In this case, the software application helps the consumer make progress towards accumulating the required number of loyalty points.

In a variation of the embodiment, some or all work in calculating scores for the matching reward offers may be performed by the loyalty program management server 5 instead of the software application, especially in respect of reward offers from the reward database 54. Alternatively or additionally, the loyalty program management server 5 may, instead of the software application, perform some or all of the work of monitoring when the consumer has accumulated enough loyalty points to obtain a desired reward.

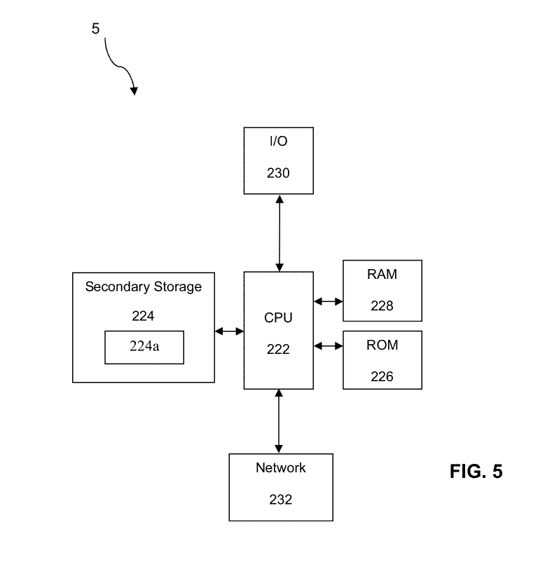

FIG. 5 is a block diagram showing a technical architecture of the loyalty program management server 5.

The technical architecture includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution.

In this embodiment, the secondary storage 224 has a processing component 224a comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 220 to provide the functionality of a number of servers that is not directly bound to the number of computers in the technical architecture 220. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 222, the RAM 228, and the ROM 226 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

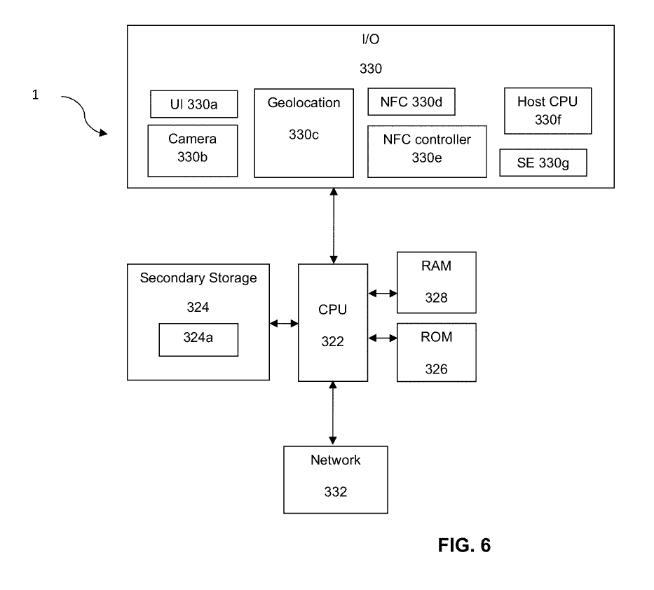

FIG. 6 is a block diagram showing a technical architecture of the communication device 1.

The technical architecture includes a processor 322 (which may be referred to as a central processor unit or CPU) that is in communication with memory devices including secondary storage 324 (such as disk drives or memory cards), read only memory (ROM) 326, random access memory (RAM) 328. The processor 322 may be implemented as one or more CPU chips. The technical architecture further comprises input/output (I/O) devices 330, and network connectivity devices 332.

The I/O devices comprise a user interface (UI) 330a, a camera 330b and a geolocation module 330c. The UI 330a may comprise a touch screen, keyboard, keypad or other known input device. The camera 330b allows a consumer to capture images and save the captured images in electronic form. The geolocation module 330c is operable to determine the geolocation of the communication device using signals from, for example global positioning system (GPS) satellites. The I/O devices further include a near field communication (NFC) unit 330d, and a controller 330e for the NFC unit 330d. The I/O devices may be supplemented by a host CPU 330f and a secure element (SE) 330g. A secure element is a tamper-resistant platform (typically a one chip secure microcontroller) capable of securely hosting applications and their confidential and cryptographic data.

The secondary storage 324 is typically comprised of a memory card or other storage device and is used for non-volatile storage of data and as an over-flow data storage device if RAM 328 is not large enough to hold all working data. Secondary storage 324 may be used to store programs which are loaded into RAM 328 when such programs are selected for execution.

In this embodiment, the secondary storage 324 has a processing component 324a, comprising non-transitory instructions operative by the processor 322 to perform various operations of the method of the present disclosure. The ROM 326 is used to store instructions and perhaps data which are read during program execution. The secondary storage 324, the RAM 328, and/or the ROM 326 may be referred to in some contexts as computer readable storage media and/or non-transitory computer readable media.

The network connectivity devices 332 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 332 may enable the processor 322 to communicate with the Internet or one or more intranets. With such a network connection, it is contemplated that the processor 322 might receive information from the network, or might output information to the network in the course of performing the above-described method operations. Such information, which is often represented as a sequence of instructions to be executed using processor 322, may be received from and outputted to the network, for example, in the form of a computer data signal embodied in a carrier wave.

The processor 322 executes instructions, codes, computer programs, scripts which it accesses from hard disk, floppy disk, optical disk (these various disk based systems may all be considered secondary storage 324), flash drive, ROM 326, RAM 328, or the network connectivity devices 332. While only one processor 322 is shown, multiple processors may be present. Thus, while instructions may be discussed as executed by a processor, the instructions may be executed simultaneously, serially, or otherwise executed by one or multiple processors.

Whilst the foregoing description has described exemplary embodiments, it will be understood by those skilled in the art that many variations of the embodiment can be made within the scope and spirit of the present invention.

1. A computer-implemented method for supplying to a consumer associated with a plurality of loyalty programs, information about reward offers offered by the loyalty programs, the method including:
receiving from the consumer input specifying one or more parameters of a desired reward;
searching a reward database storing information relating to reward offers from the plurality of loyalty programs, to identify reward offers relating to rewards matching the specified parameters; and
presenting information about at least one of the identified reward offers to the consumer,
whereby the consumer can select one of the identified reward offers, thereby selecting a corresponding one of the plurality of loyalty programs.

2. A method according to claim 1 further including generating a score for each of the identified reward offers using one or more score criteria, and presenting the information about the identified reward offers according to the corresponding scores.

3. A method according to claim 2 in which at least one of the score criteria is based on a ratio between a monetary price of the corresponding reward and the number of loyalty points which is required to obtain the reward.

4. A method according to claim 2 in which at least one of the score criteria is whether the consumer has accumulated enough loyalty points to pay for the reward.

5. A method according to claim 2 in which at least one of the score criteria is based on a prediction of loyalty points the consumer will earn in the future according to a consumer model generated based on the consumer's past behaviour.

6. A method according to any of claim 2 in which at least one of the score criteria is a function of a geographical location associated with the consumer and a geographical location associated with the reward offer.

7. A method according to claim 1 further including:
receiving, from the consumer, data input specifying one of the identified reward offers; and
displaying data to the consumer notifying the consumer of one or more redemption locations where the matching reward can be obtained.

8. A method according to claim 1 further including:
receiving from the consumer data input specifying one of the identified reward offers, the reward offer being associated with a required number of loyalty points which is higher than a number of loyalty points accumulated by the consumer;
monitoring accumulation of loyalty points by the consumer; and
upon the accumulated loyalty points being at least as high as the required number of loyalty points, sending a message to the consumer.

9. A method according to claim 8 further including, upon receiving data input from the consumer, displaying to the consumer information about the points accumulated in each of the loyalty programs.

10. A computer server system for obtaining, and presenting to a consumer, information about reward offers offered by a plurality of loyalty programs, the computer system including:
(a) a communication interface for receiving, from a communication device associated with the consumer, data specifying one or more parameters of a desired reward;
(b) a reward database storing information relating to reward offers from the plurality of loyalty programs; and
(c) a processor operative to:
(i) collect from loyalty program servers associated with a plurality of corresponding loyalty programs data characterizing reward offers offered by the plurality of loyalty programs;
(ii) store the data characterizing the reward offers by the plurality of loyalty programs in a rewards database;
(iii) perform a search in the rewards database to identify reward offers relating to rewards matching the specified parameters;
(iv) generate a score for each of the identified reward offers based on one or more score criteria, and
(v) transmit data to the communication device containing information about each of identified rewards to the consumer, and data causing the communication device to present the information to the user according to the score of the corresponding reward offer;
whereby the consumer can select one of the identified reward offers, thereby selecting a corresponding one of the plurality of loyalty programs.

11. A computer server system according to claim 10 further including at least one consumer database containing information about the plurality of loyalty programs with which the consumer is associated and the number of points the consumer has accumulated in each of the plurality of loyalty programs, the processor being operative to collect from the loyalty program servers data characterizing loyalty points accumulated by the consumer, and store the data in the consumer database.

12. A computer server system according to claim 10 in which at least one of the score criteria is based on a ratio between a price of the corresponding reward and a required number of loyalty points associated with the identified reward offer.

13. A computer server system according to claim 10 in which at least one of the score criteria is based on whether a number of loyalty points accumulated by the consumer exceeds a required number of loyalty points associated with the identified reward offer.

14. A computer sever system according to claim 10 in which at least one of the score criteria is based on a prediction of loyalty points the consumer will earn in the future according to a consumer model.

15. A computer server system according to claim 10 in which at least one of the score criteria is a function of a geographical location associated with the consumer and a geographical location associated with the reward offer.

16. A computer server system according to claim 10 in which the processor is operative to:
receive data input specifying one of the identified reward offers,
determine that the specified reward offer is associated with a required number of loyalty points which is higher than a number of loyalty points accumulated by the consumer;
monitor accumulation of loyalty points by the consumer; and
upon the accumulated loyalty points being at least as high as the required number of loyalty points, send a message to the consumer.
